(19) United States
(12) Patent Application Publication
(10) Pub. No.: US 2014/0200696 A1
(43) Pub. Date: Jul. 17, 2014

(54) PROCESS FLOW OPTIMIZATION IN MANUFACTURING

(71) Applicant: J&L Group International, LLC, Keithville, LA (US)

(72) Inventors: Marius D. Batrin, Liberty Lake, WA (US); Richard W. Wilkinson, Friendswood, TX (US)

(21) Appl. No.: 14/152,218

(22) Filed: Jan. 10, 2014

Related U.S. Application Data
(60) Provisional application No. 61/751,631, filed on Jan. 11, 2013.

(51) Int. Cl. G05B 19/418

(52) U.S. Cl. CPC G05B 19/418
USPC 700/95

(57) ABSTRACT

Optimizing a multiple machine production line, in which operation of at least some of the machines depends on others. A productivity system examines performance indicators of a set of machines, which are disposed to cooperate in a production line, and sets control variables for each of those machines, with the effect of optimizing the production line. The productivity system receives a set of KPIs for each machine, and provides a set of control variables for each machine. The productivity system determines the control variables for each machine so as to optimize the production line.

### BACKGROUND

1. Field of the Disclosure

This application generally relates to process flow optimization in manufacturing, and related matters. For example, this application includes material generally relating to process flow optimization in manufacturing of corrugated boxes, and related matters.

2. Background of the Disclosure

In a manufacturing operation, optimizing performance of individual machines does not always provide good results for the manufacturing line. For example, it sometimes occurs that one machine operates too quickly or too slowly, or becomes stopped for some reason. For a first example, in such cases, a machine that operates too quickly might produce too much input for the next machine in a production line. For a second example, in such cases, a machine that stops for any reason might cause other machines in the production line to have to stop as well.

Each of these examples, as well as other possible considerations, can cause difficulty and inefficiency in aspects of a manufacturing production system in which more than one machine must cooperate. This might be an issue when the manufacturing production system includes a production line in which many of the machines' operation depend on a result from an earlier machine in the production line. Since each machine can cause difficulty for others in the production line, operation of multiple machines without taking into account their interaction can cause difficulty in optimizing the production line.

### SUMMARY OF THE DISCLOSURE

This application provides techniques that optimize a production line having multiple machines, in which operation of at least some of the machines depends on others.

In one embodiment, a productivity system examines performance indicators of a set of machines, which are disposed to cooperate in a production line, and sets control variables for each of those machines, with the effect of optimizing the production line. The productivity system receives a set of key performance indicators (KPIs) for each machine, and provides a set of control variables for each machine. For example, possible KPIs could include one or more of the following: (A) Possible KPIs could include whether the machine is “active”, that is, operational and ready to process material. (B) Possible KPIs could include whether the machine is “starved”, that is, able to operate, but no material is available. (C) Possible KPIs could include whether the machine is “full”, that is, able to operate but no space is available to buffer further material. (D) Possible KPIs could include a current run rate or cycle time. (E) Possible KPIs could include information about machine status or operability. (F) Possible KPIs could include an average or other measure of wait time for operation. (G) Possible KPIs could include a current bundle (or unit) ID, sheet (or unit) ID, or load (or unit) ID. Possible KPIs could possibly include other indicators, measures or tests.

In one embodiment, the productivity system determines the control variables for each machine so as to optimize the production line. For example, the productivity system can optimize the flow of material goods, such as partial products, as they are manufactured by the production line. In such cases, this can optimize the amount of finished goods produced per unit time, optimize the efficiency of the production line, minimize the amount of “down time” for machines in the production line, minimize the mean time between failures (MBTF) of the production line, and other measures of production line quality.

After reading this application, those skilled in the art would recognize that techniques shown in this application are applicable to fields and information other than manufacturing systems. In the context of the invention, there is no particular requirement for any such limitation. Moreover, after reading this application, those skilled in the art would recognize that techniques shown in this application are applicable to methods and systems other than those involving manufacturing of physical devices such as boxes. For example, other manufacturing contexts can include assembly lines, chemical processes, semiconductor manufacturing, and otherwise.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

FIG. 1A and FIG. 1B are sometimes collectively referred to herein as FIG. 1. FIG. 1A shows a first conceptual drawing of an example production line. FIG. 1B shows a second conceptual drawing of an example production line.

FIG. 2 shows a first conceptual drawing of a system that optimizes a production line.

FIG. 3 shows a second conceptual drawing of a method of optimizing a production line.

### DETAILED DESCRIPTION

Example Production Line

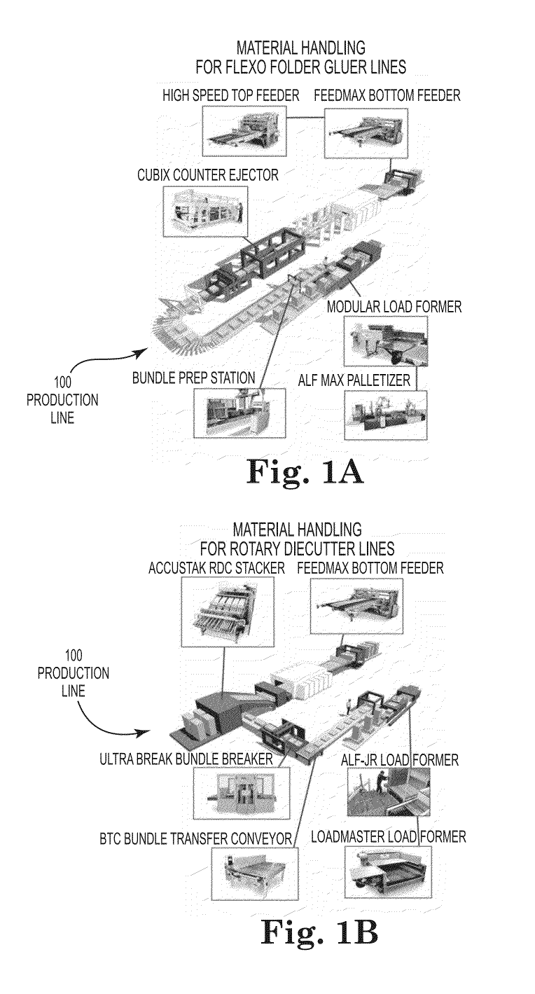

FIG. 1A and FIG. 1B are sometimes collectively referred to herein as FIG. 1. FIG. 1A shows a first conceptual drawing of an example production line. FIG. 1B shows a second conceptual drawing of an example production line.

Elements of the system are described herein with respect to one or more possible embodiments; and are not intended to be limiting in any way. In the context of the invention, there is no particular requirement for any such limitations as described with respect to any elements of the system. For example, individual elements of the system 100 could be replaced with substitutes that perform similar functions. Moreover, as described herein, many individual elements of the system are optional, and are not required for operation.

In one embodiment, a production line 100 can include a sequence of machines 110, such as could be used in material handling. For a first example, material handling can include folding and gluing devices, such as could be used to make boxes or other cardboard constructs from corrugated cardboard, plastic, or other materials. For a second example, material handling can include rotary die cutting devices, such as could be used to make foldable elements from corrugated cardboard, plastic, or other materials.

In one embodiment, the production line 100 can include a corrugator, that is, a device for constructing corrugated fiberboard or related materials. For example, a manufacturing plant would typically include a single corrugator, although it is possible for each production line 100 to include its own corrugator. In one embodiment, the production line 100 can include a stack conveyor, such as one stack conveyor for each production line 100.

In one embodiment, the production line 100 can include one or more devices, each disposed to conduct one or more procedures according to the production line 100, such as including one or more of the following: an inverter, a load conveyor, and other devices.

FIG. 1A shows a first conceptual drawing of an example production line, such as could be used for folding and gluing. In cases in which material handling includes folding and gluing devices, the production line 100 can include one or more of the following: a feeder element that retrieves die cut foldable box material, a folder gluer that folds and glues material into boxes, a stacker that stacks boxes, a palletizer that composes stacked boxes onto pallets, a load conveyor that moves pallets into a shipping configuration, and otherwise. In such examples, the production line can include either a bottom feeder element or a top feeder element; a counter ejector element; a bundle preparation element; a load former element; a palletizer element; one or more conveyors for moving input materials, work in progress, and finished objects; and possibly other elements.

FIG. 1B shows a second conceptual drawing of an example production line, such as possibly for rotary die cutting. In cases in which material handling includes rotary die cutting devices, the production line 100 can include one or more of the following: a feeder element that retrieves raw corrugated cardboard or other material, a rotary die cut press that cuts and creases the material, a printer/conveyor that prints and further conveys units of the material, a bundle breaker that breaks the creased material into stackable elements, a strapper that packages the bundles into stackable bundles of units, a stacker that stacks bundles, a bundle conveyor that conveys bundles to a shipping or further processing location, and otherwise. In such examples, the production line can include a bottom feeder element; a stacker element; a bundle breaker element; one or more load former elements; one or more conveyors for moving input materials, work in progress, and finished objects; and possibly other elements.

Method Of Operation (I)

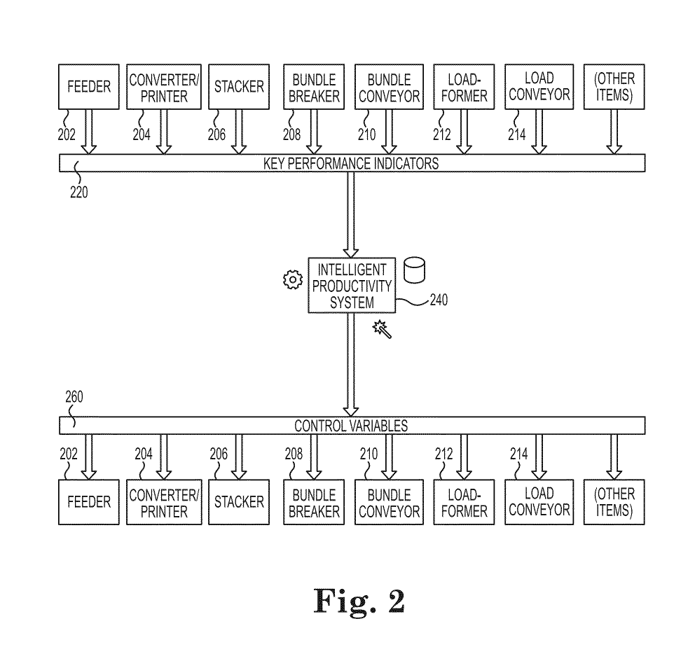

FIG. 2 shows a first conceptual drawing of a system that optimizes a production line.

In one embodiment, the production line 100 can include a feeder element 202, a converter/printer element 204, a stacker element 206, a bundle breaker element 208, one or more bundle conveyor elements 210, a load former element 212, one or more load conveyor elements 214, and possibly other elements.

In one embodiment, substantially each such element can contribute data or other information to be interpreted as one or more key performance indicators (KPIs) 220, which can describe the state of the element or other operational information about the element.

For one example, one or more KPIs 220 can describe whether or not the particular element is in one or more of the following states. (A1) The particular element can be in a “FAULTED” state, that is, is not fully operational or otherwise broken. (A2) The particular element can be in a “STARVED” state, that is, not having input, or otherwise not able to process input. (A3) The particular element can be in a “FULL” or “SATURATED” state, that is, having a full input buffer, or otherwise not able to accept further input. (A4) The particular element can be in an “ACTIVE” state, that is, operational or at least partially operational. (A5) The particular element can be in another state, such as partially or wholly operable or inoperable.

For a second example, the particular element can have one or more other KPIs 220, such as one or more other states, or one or more other items of data or information. Other KPIs 220 or other states can include one or more of the following. (B1) The particular element can have a current run rate or cycle time, that is, a measure of how quickly the particular element is processing goods, or a measure of how quickly the particular element is moving. In such cases, the particular element can have its run rate or cycle time expressed in RPM or some other measure. (B2) The particular element can have an average wait time, that is, a measure of how much latency there is between processing items, or a measure of how much time it takes to process any one item. (B3) The particular element can have an indicator of which item it is processing at the moment, such as a current bundle ID, a current sheet ID, a current load ID, or otherwise. (B4) The particular element can have another indicator.

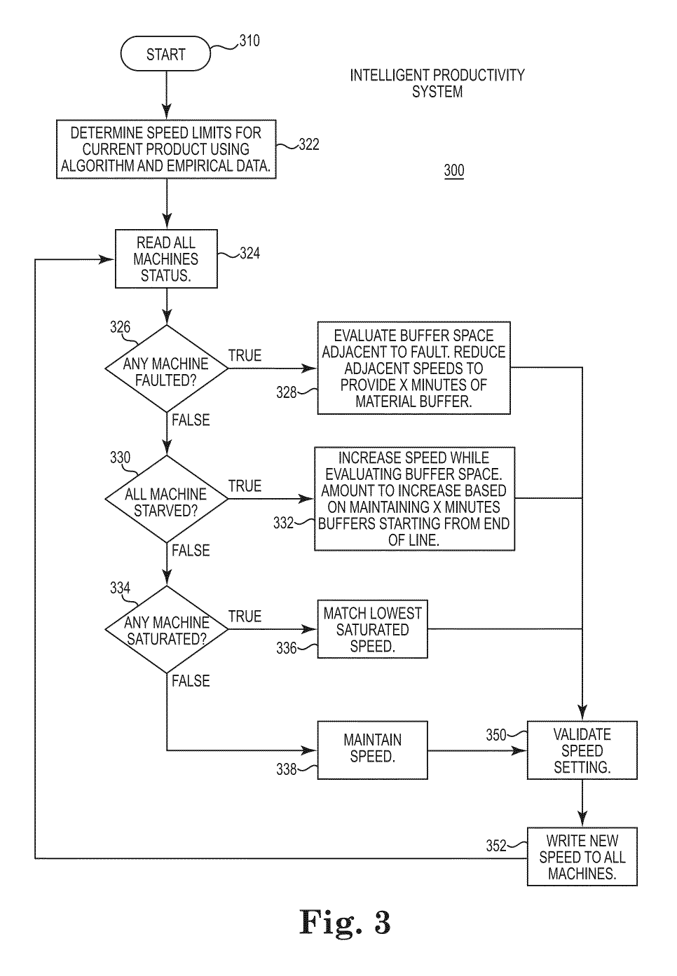

The KPIs 220 can be collected and communicated to an Intelligent Productivity (or Intelligent Productivity System) element 240, which can receive the one or more KPIs 220 and generate one or more control variables 260. In one embodiment, the Intelligent Productivity element 240 can include a processor, program, data memory or mass storage, and instructions. For example, the instructions can be maintained in non-volatile program and data memory or mass storage, and are interpretable by the processor to direct the Intelligent Productivity element 240 to receive the one or more KPIs 220 and generate the one or more control variables 260. In such cases, the instructions can include specific techniques that generate the one or more control variables 260 in response to the one or more KPIs 220. This is described further below, with respect to FIG. 3.

The one or more control variables 260 can be communicated between the Intelligent Productivity element 240 and the elements included in the production line 100. For example, the one or more control variables 260 can be communicated to the feeder element 202, the converter/printer element 204, the stacker element 206, the bundle breaker element 208, the one or more bundle conveyor elements 210, the load former element 212, the one or more load conveyor elements 214, and possibly other elements.

In one embodiment, substantially each such element can receive data or other information to be interpreted as one or more control variables 260, which can describe directions or instructions to the element with respect to the state of the element or other operational information about the element.

For example, one or more control variables 260 can describe a state the element should enter or a condition the element should take on, such as one or more of the following states. (C1) The particular element can be directed to stop, start, pause, resume, or otherwise begin or cease operation. (C2) The particular element can be directed to operate at a selected speed, a selected latency between items, or otherwise operate faster or slower. (C3) The particular element can be directed to skip one or more items. (C4) The particular element can have another control variable.

In one embodiment, the KPIs 220 collected and communicated to the Intelligent Productivity element 240 can include those described above, or otherwise: an order ID, an item size (such as a size of a box or sheet to be processed), an orientation (such as an orientation of the item with respect to the processing element), a run state, a fault state, a cycle time, or otherwise. The Intelligent Productivity element 240 can, by the processor in response to the instructions, determine whether or not to change the operation of the production line 100.

EXAMPLE USES OF CONTROL VARIABLES. In one embodiment, the Intelligent Productivity element 240 can use the control variables 260 to vary the speed of one or more processing elements, such as to optimize the flow of items through the production line 100. For a first example, when downstream elements enter the “STARVED” state, the Intelligent Productivity element 240 can increase the speed of upstream elements. For a second example, when downstream elements enter the “SATURATED” state, the Intelligent Productivity element 240 can use the control variables 260 to decrease or maintain the speed of upstream elements.

In one embodiment, the Intelligent Productivity element 240 can use the control variables 260 to vary the speed of, or to pause and resume, operation of one or more processing elements, such as in response to one or more elements entering the “FAULT” state. For example, when a downstream element enters the “FAULT” state, the Intelligent Productivity element 240 can slow down or pause one or more upstream elements, with the effect that those upstream elements could be prevented from overfilling their output buffers. It might occur that the production line 100 can be slowed somewhat while an operator corrects the “FAULT” state. It alternatively might occur that the production line 100 can be slowed further, or paused, if it takes a substantial time to correct the “FAULT” state.

In one embodiment, the Intelligent Productivity element 240 can collect the KPIs 220 and determine whether any downstream device is in the “FAULT” state. If so, the Intelligent Productivity element 240 can slow the production line 100 for a first selected time duration, while an operator can attempt to correct the “FAULT” state. After that first time duration, the Intelligent Productivity element 240 can slow the production line 100 further for a second selected time duration, while the operator further attempts to correct the “FAULT” state. After that second time duration, the Intelligent Productivity element 240 can pause the production line 100 until the operator indicates that the “FAULT” state has been successfully corrected.

FURTHER USES OF CONTROL VARIABLES. In one embodiment, the Intelligent Productivity element 240 can collect statistical information, with the effect of determining one or more locations in the production line 100 where action can be taken to optimize parameters, such as for best production throughput or best reliability or longevity of production devices.

For a first example, the Intelligent Productivity element 240 can determine that one particular production element is a bottleneck or otherwise is a limiting factor in a speed or throughput of the production line 100. In a first case, the Intelligent Productivity element 240 can attempt to optimize that particular production element. In a second case, the Intelligent Productivity element 240 can alert an operator of the bottleneck or limiting factor, with the effect that the operator can adjust (or replace) the particular production element.

For a second example, the Intelligent Productivity element 240 can determine that one particular production element is likely to enter the “FAULT” state more frequently than desirable. This might indicate that the particular production element is breaking down, performing inconsistently, performing in a manner inconsistent with its parameters, jamming, or otherwise subject to error. This might be due to the speed of the production line 100, or other factors. In a first case, the Intelligent Productivity element 240 can attempt to optimize that particular production element, with the effect of reducing the frequency of that particular production element is likely to entering the “FAULT” state. In a second case, the Intelligent Productivity element 240 can alert an operator of the bottleneck or limiting factor, with the effect that the operator can adjust (or replace) the particular production element. In a third case, the Intelligent Productivity element 240 can alert an operator of a need for maintenance on a given component, either imminently or at a convenient opportunity.

For a third example, the Intelligent Productivity element 240 can determine an optimal set of speeds at which to recover from a production element having entered the “FAULT” state, and later been adjusted to correct that “FAULT” state. It might occur that the production line 100 is best restarted at a relatively slow speed, and increased in speed gradually to its optimum speed (rather that restarting at maximum speed). In such cases, the Intelligent Productivity element 240 can determine a sequence of one or more speed settings, and other parameters, with which to control the production line 100 upon restart.

For a fourth example, the Intelligent Productivity element 240 can determine an optimal set of speeds with which to control the production line 100 upon pausing one or more production elements, with the effect that a pause/resume operation at an upstream element does not cause a cascade of pause/resume or start/stop operations at downstream elements.

For a fifth example, the Intelligent Productivity element 240 can determine an optimal set of settings with which to control the production line 100 in the event of a special production order. In such cases, it might occur that a particular production order is optimized with a distinct set of settings, different from usual. This would have the effect that an operator would be able to enter a description of that particular production order at a single operator station, with the effect that the Intelligent Productivity element 240 could then optimize the production line 100 in response thereto. Moreover, the Intelligent Productivity element 240 can optimize the production line 100 in response to a sequence of individual production orders as they occur, such as in response to input of that sequence of individual production orders by an operator.

For a sixth example, the Intelligent Productivity element 240 can determine an optimal set of settings with which to control the production line 100, such as a speed setting that provides relatively reduced downtime, relatively reduced equipment jams, and relatively reduced equipment wear. For example, instead of attempting to operate the production line 100 at a maximum speed, with relatively frequent pause/resume operations, the Intelligent Productivity element 240 can operate the production line 100 at a relatively lesser speed, with relatively infrequent pause/resume operations. A relatively lesser number of pause/resume operations can also provide for a relatively lesser amount of use of test sheets, with the effect of producing a relatively lesser amount of output scrap.

For a seventh example, the Intelligent Productivity element 240 can determine a relatively consistent operator interface for determining settings with which to control the production line 100. This can have the effect of providing a consistent and extensible framework for the operator interface to be applied to setting parameters for each particular production element, as well as providing operators with relative ease of use in learning how to use each particular production element. This can also have the effect of providing a consistent framework for programming of individual production elements, with the effect that individual production elements can each have a relatively general way in which the Intelligent Productivity element 240 can set their control variables 260.

Method of Operation (II)

FIG. 3 shows a second conceptual drawing of a method of optimizing a production line.

A method 300 of using an example system includes flow labels and method steps as described herein. In one embodiment, the method steps can be performed in an order as described herein. However, in the context of the invention, there is no particular requirement for any such limitation. For example, the method steps can be performed in another order, in a parallel or pipelined manner, or otherwise.

In this description, where the “method” is said to arrive at a flow point or to perform a method step, that flow point is arrived at, or that method step is performed, by one or more machines associated with performing the method 300. In one embodiment, the method 300 can be performed by a control device separate from the machines in the production line. In alternative embodiments, the method 300 can be performed by one or more of the machines in the production line, such as operating in conjunction or cooperation, or such as each performing one or more parts of the method 300.

Similarly, although one or more method steps are described herein as being performed by a single device, in the context of the invention, there is no particular requirement for any such limitation. For example, the one or more devices can include a cluster of devices, not necessarily all similar, on which the method steps are performed, such as a cloud computing execution platform or cluster computing platform. Also, while this application generally describes one or more method steps as distinct, in the context of the invention, there is no particular requirement for any such limitation. For example, the one or more method steps could include common operations, or could even include substantially the same operations.

READY TO BEGIN. At a flow point 310, the method 300 is ready to begin.

At a step 322, the method 300 determines one or more limiting factors, such as speed limits of partial products being processed by the production line. In one embodiment, the method 300 can determine one or more limiting factors in response to the KPIs, in response to empirical data with respect to the production line, and in response to a computation with respect to those KPIs and that empirical data. For example, the method 300 can determine a speed limit in response to whether all machines in the production line are “active”, whether any machines in the production line are “starved”, and the like.

At a step 324, the method 300 determines the status of machines in the production line. For example, the method 300 can read a set of status indicators provided by those one or more machines. In one embodiment, the method 300 determines the status of all such machines. However, in the context of the invention, there is no particular requirement for any such limitation. For a first example, the method 300 can read the status of one or more machines at a time, in a round-robin or other time-multiplexed fashion. For a second example, the method 300 can read the status of one or more selected machines, such as those machines deemed to have bottleneck features with respect to the production line.

ANY MACHINES FAULTED? At a step 326, the method 300 determines if any machine is in a “faulted” state. For example, upon reading the status indicators for the machines, the method 300 can determine whether all machine states are consistent with good working order. For a first example, a machine can indicate that it is not in good working order by signaling a fault, or a machine can indicate that it is not in good working order by failing to signal indicators that are consistent with good working order. For a second example, the method 300 can poll the machines in the production line, asking each one its state, and determining if those states are both individually and collectively consistent with good working order. As part of this step, if the method 300 determines that any machine is (or if a few machines are) in a “faulted” state, the method 300 proceeds with the next step. Alternatively, if the method 300 determines that no machine is (or only a few machines are) in a “faulted” state, the method 300 proceeds with the step 330.

At a step 328, the method 300 queries those devices adjacent to the machine in the “faulted” state (or otherwise near to the machine in the “faulted” state). As part of this step, the method 300 reviews the amount of buffer space for those machines, and determines a speed at which those machines can be run while still maintaining at least X minutes of buffer material, where X is a parameter selected by the method 300.

As part of this step, the method 300 directs those machines (adjacent to the machine in the “faulted” state, or otherwise near to the machine in the “faulted” state) to reduce speed sufficiently that they can maintain at least X minutes of buffer material.

This can apply to those machines upstream of the faulted machine, because machines upstream of the faulted machine would rapidly produce partial products that would not be able to be processed until the fault is corrected. This can also apply to those machines downstream of the faulted machine, because machines downstream of the faulted machine would become starved of partial products upon which to operate after their X minutes of buffer material are used up. After this step, the method 300 proceeds with the flow point 350.

ALL MACHINES STARVED? At a step 330, the method 300 determines if the machines are substantially all in “starved” states. For example, upon reading the status indicators for the machines, the method 300 can determine whether all machine states are consistent with having a empty buffer. For a first example, a machine can indicate that it is in a starved state by signaling a particular type of fault, such as a “starved” fault, or a machine can indicate that it is in a starved state by failing to signal that it has pending input. As part of this step, if the method 300 determines that all machines (or all but a few machines) are in a “starved” state, the method 300 proceeds with the next step. Alternatively, if the method 300 determines that at least some machines (or at least a few machines) are not in a “starved” state, the method 300 proceeds with the step 332.

At a step 332, the method 300 queries those devices starting from the end of the production line with respect to the amount of buffer space they have available. As part of this step, the method 300 reviews the amount of buffer space for those machines, and determines a speed at which those machines can be run while still maintaining at least X minutes of buffer material for all such machines, where X is (as noted above) the parameter selected by the method 300.

As part of this step, the method 300 determines a speed at which those machines can be run while still maintaining at least X minutes of buffer material, where X is the parameter selected by the method 300. As part of this step, the method 300 reviews the amount of buffer space for those machines, and directs the machines in the production line to increase speed while still maintaining at least X minutes of buffer material. After this step, the method 300 proceeds with the flow point 350.

ANY MACHINE SATURATED? At a step 334, the method 300 determines if any machine is saturated, that is, “full”, thus no longer able to accept input buffered pieces. For example, upon reading the status indicators for the machines, the method 300 can determine whether all machine states are consistent with having a full buffer. For a first example, a machine can indicate that it is in a saturated state by signaling a particular type of fault, such as a “full” fault, or a machine can indicate that it is in a saturated state by failing to signal that it has any available input buffer space. As part of this step, if the method 300 determines that any machine is (or if a few machines are) in a “full” state, the method 300 proceeds with the next step. Alternatively, if the method 300 determines that no machine is (or only a few machines are) in a “full” state, the method 300 proceeds with the step 338.

At a step 336, the method 300 directs the machines in the production line to match the lowest speed of any machine in a “full” state. After this step, the method 300 proceeds with the flow point 350.

At a step 338, the method 300 directs the machines in the production line to each maintain their current speed. After this step, the method 300 proceeds with the flow point 350.

READY TO VALIDATE SETTINGS. At a flow point 350, the method 300 validates the speed setting it has directed the machines in the production line to take. In one embodiment, the method 300 confirms that each machine has been directed to take on a speed consistent with a speed at which it is able to operate, consistent with maintaining at least X minutes of buffer material, where X is the parameter selected by the method 300. If so, the method 300 proceeds with the next step. If not, the method 300 adjusts the speed settings for each machine for validity, that is, each machine is maintained at a speed at which it is able to operate, again, consistent with maintaining at least X minutes of buffer material, where X is the parameter selected by the method 300. If adjusting the speed settings for validity would be inconsistent with settings directed by the method 300 in other steps, the method 300 might return to those steps to re-evaluate new settings.

At a step 352, the method 300 writes the new speed settings to all machines (or substantially all machines) in the production line. After this step, the method 300 proceeds with the step 324 above, where it repeats the step of reading machine status.

While this method of operation has been primarily described with respect to speed settings for machines in the production line, in the context of the invention, there is no particular requirement for any such limitation. For example, methods of operation can be performed that control input buffer size or other characteristics that can be varied with respect to machines in the production line. Similarly, while this method of operation has been primarily described with respect to the same characteristic (that is, a speed setting) for all machines in the production line, in the context of the invention, there is no particular requirement for any such limitation. For example, methods of operation can be performed that control distinct machines differently, as might be appropriate to distinct control parameters available for those distinct machines In such examples, methods of operation could be performed that control input buffer size for a first set of machines, and that control speed settings for a second set of machines, or otherwise.

ALTERNATIVE EMBODIMENTS. After reading this application, those skilled in the art would recognize many of the advantages of this description, and would recognize that various changes may be made in the form, construction, and arrangement of the components without departing from the scope or spirit of the subject matter or without sacrificing its advantages. Those embodiments described herein are merely explanatory and illustrative. While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

Aspects of the embodiments described herein could be provided as a computer program product, such as may include a computer-readable storage medium or a non-transitory machine-readable medium maintaining instructions interpretable by a computer or other electronic device, such as to perform one or more processes. A non-transitory machine-readable medium includes any mechanism for storing information in a form (including a processing application or software) readable or interpretable by a machine (such as a computer). The non-transitory machine-readable medium may take the form of, but is not limited to, any known storage technique, including magnetic storage media, optical storage media, magneto-optical storage media; read only memory (ROM); random access memory (RAM); erasable programmable memory (including EPROM and EEPROM); flash memory; and otherwise.

1. A method of optimizing a multiple machine line, comprising:
collecting one or more key performance indicators for one or more elements on a production line;
storing said one or more key performance indicators in a buffer;
using a computer to analyze said key performance indicators;
outputting control variables to one or more of the elements on said production line, to increase the efficiency of said production line.

2. The method of claim 1, wherein:
said key performance indicators include one or more of whether one or more of each elements is active, whether any element is starved, whether each element is full, a current run rate or cycle time, information about element status or operability, wait time for operation, and information relating to a given unit being processed

3. The method of claim 2, wherein:
the efficiency of said production line is increased by increasing finished goods produced per unit time.

4. The method of claim 2, wherein:
the efficiency of said production line is increased by decreasing the amount of down time for one or more elements in the production line

5. The method of claim 2, wherein:
the efficiency of said production line is increased by decreasing the mean time between failures on the production line.

6. The method of claim 2, wherein:
the efficiency of said production line is increased by increasing the overall average speed of said production line.

7. The method of claim 1, wherein:
one or more of said key performance indicators indicate whether any element is in one or more of the following states: faulted, starved, saturated, operable, and active.

8. The method of claim 1, wherein:
one or more of said key performance indicators indicate whether any element is partially or wholly inoperable.

9. The method of claim 1, wherein:
said computer includes a storage medium.

10. The method of claim 1, wherein:
said computer includes non-transitory machine-readable medium.

11. The method of claim 10, wherein:
said non-transitory machine-readable medium comprises one or more of magnetic storage media, optical storage media, magneto-optical storage media, read only memory, random access memory, erasable programmable memory, and flash memory.
